(19) United States
(12) Patent Application Publication
(10) Pub. No.: US 2026/0216733 A1
(43) Pub. Date: Jul. 30, 2026

(54) SYSTEM AND METHOD FOR SHREDDING OF LITHIUM-ION BATTERIES

(71) Applicant: METASTABLE MATERIALS PRIVATE LIMITED, Baghpat, Uttar Pradesh (IN)

(72) Inventors: Shubham VISHVAKARMA, Baraut (IN); Manikumar UPPALA, Nalgonda (IN)

(73) Assignee: METASTABLE MATERIALS PRIVATE LIMITED, Baghpat, Uttar Pradesh (IN)

(21) Appl. No.: 18/745,978

(22) PCT Filed: Mar. 25, 2023
(86) PCT No.: PCT/IN2023/050288

§ 371 Date: Jun. 17, 2024

(30) Foreign Application Priority Data
Mar. 25, 2022 (IN) 202211017133

(51) Int. Cl. B02C 18/14; B02C 23/36; B02C 25/00; H01M 10/0525; H01M 10/54

(52) U.S. Cl. CPC B02C 18/14; B02C 23/36; B02C 25/00; H01M 10/0525; H01M 10/54

(57) ABSTRACT

The various embodiments of the present invention provide provides a single integrated system that is designed to shred Lithium-ion batteries and handle all the associated complex processes and effects. The present invention also provides a system for classification of shredded material. The system comprises a hourglass shaped apparatus and the shredder is placed at the neck of the apparatus. The upper bulb of the hourglass shaped apparatus is electrically heated/cooled using submerged water heater/chillers. and comprises a chamber at the top for collecting exhaust gases. The lower bulb of the hourglass shaped apparatus includes a screen placed at the middle of the chamber with a tilt and a shaking mechanism. This is a sieve arrangement, and it is used for classification of undersized and oversized material. The gases exhausted during shredding operation are collected at top and are sent to a scrubber to neutralize any acidic gases.

### REFERENCE TO RELATED APPLICATION

The embodiments herein claim the priority of the Indian Provisional Patent Application filed on Mar. 25, 2022, with the number 202211017133 and PCT Applic. No. PCT/IN2023/050288, filed Mar. 25, 2023, the contents of which are incorporated herein by reference.

### FIELD OF THE INVENTION

The present invention is generally related to Lithium-ion batteries. The present invention is more particularly related to a system and method for safely shredding Lithium-ion batteries.

### BACKGROUND OF THE INVENTION

The shredding of used Lithium-ion batteries is a process that needs specialized conditions for safe disposal of the shredded batteries due to the danger of explosion, fire and other hazard during the shredding process. Current methods for shredding is a multi-step and multi equipment process include using a multi-shaft shredder in a neutral atmosphere of Nitrogen or Argon, or in cryogenic conditions.

In some current implementations, recyclers are provided with sprayers to spray water with additives into the shredding environment. However, this method only mitigates some of the issues and do not completely solve the problems. Additionally, this method also requires discharging of batteries, removal of protective layers, casing and supporting infrastructure to put the batteries in the shredder. Though the process is performed in conventional manner, it incurs high capital, operating and maintaining costs along with being complex to execute, and does not produce favorable results as well.

Hence, there exists a need for a single integrated system that is designed to safely shred Lithium-ion batteries and handle all the associated complex processes and effects. There also exists a need for a system for classification of shredded material during the shredding of Lithium-ion batteries.

The abovementioned shortcomings, disadvantages and problems are addressed herein, which will be understood by reading and studying the following specification.

### OBJECT OF THE INVENTION

The primary object of the present invention is to provide a system and method for safely shredding Lithium-ion batteries.

Another object of the present invention is to provide a system for shredding Lithium-ion batteries in a fluid environment.

Yet another object of the present invention is to provide a system for classification of shredded material after the shredding of Lithium-ion batteries and reshredded the large particles.

Yet another object of the present invention is to provide a system for safe and non-hazardous handling of organic and inorganic exhaust during the shredding of Lithium-ion batteries.

These and other objects and advantages of the present invention will become readily apparent from the following detailed description taken in conjunction with the accompanying drawings.

### SUMMARY OF THE INVENTION

The various embodiments of the present invention provide a system and method for safely shredding Lithium-ion batteries. The embodiments also provide a system for shredding Lithium-ion batteries in a fluid environment that is enabled with classification of material during the shredding of Lithium-ion batteries.

According to one embodiment of the present invention, a system for shredding Lithium-ion batteries is provided. The system comprises a hourglass shaped apparatus and the shredder is placed at the neck of the apparatus. The upper bulb of the hourglass is electrically heated or cooled using submerged water heaters or chiller. The upper bulb is also connected to the material inlet and comprises a chamber at the top for collecting exhaust gases. According to one embodiment, the lower bulb of the hourglass shaped apparatus comprises a screen placed at the middle of the chamber with a tilt and a shaking mechanism. This is a sieve arrangement, and it is used for classification of undersized and oversized material. The undersized material is exported out of the system while the oversized material is cycled back with feed material for reshredding. The movement of material of both undersized and oversized is accomplished using a plurality of screw conveyors, wherein the screw conveyors are run at pre-calibrated constant speed. The intra equipment conveyor is run at higher speed than outlet conveyor to create a flow of a fluid, such as water, inside the equipment for equal distribution of heat.

According to one embodiment of the present invention, the gases exhausted during shredding operation are collected at top and are sent to a scrubber to neutralize any acidic gases, wherein this function is accomplished using a control valve and pressure sensor. The placement of chamber and pump above it also creates a negative pressure. The gases left after scrubbing are compressed and stored. Both the upper bulb and lower bulb, along with the non-sliding parts of shredder assembly, are coated with protective coating such as Teflon or Nickel, to protect the equipment from leached products produced from the shredding operation. The shredder is connected to a motor using a belt drive connected via motor using a large pulley.

According to one embodiment of the present invention, the motor is connected via a set of gears. A pulley is provided to create some inertia in the system so that minor alteration in torque requirement is handled. There is also a mechanism that detect shredder choke, and when the choke is detected, it reverses the direction of motion for a certain amount of time. The electrical heating/cooling system is controlled using a PID controller and a plurality of thermocouples are placed to monitor temperature uniformity.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIGS. 1a and 1b illustrate the front view and isometric views of a system for providing integrated and safe shredding of Lithium-ion batteries, according to one embodiment of the present invention.

FIGS. 2a, 2b and 2c illustrate the front view and side views of yet another system for providing integrated and safe shredding of Lithium-ion batteries, according to one embodiment of the present invention

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for safely shredding Lithium-ion batteries. The embodiments also provide a system for shredding Lithium-ion batteries in a fluid environment that is enabled with classification of material during the shredding of Lithium-ion batteries.

According to one embodiment of the present invention, a system is provided for shredding Lithium-ion batteries is provided. The system comprises a dual-chamber apparatus, a shredder, a sieve, a plurality of conveyors, a motor, and a plurality of sensors and actuators. The dual-chamber apparatus comprises an upper chamber and a lower chamber such that the two chambers are mechanically coupled through a narrow neck region, and both the chambers broaden as they move away from the neck region, thereby providing an hourglass-shape to the dual-chamber apparatus. The dual-chamber apparatus enables safe shredding of Lithium-ion batteries by providing a temperature-controlled fluid environment inside the chambers. The shredder is placed at the neck of the dual-chamber apparatus. The width of the shredder is adjusted for size characterization of shredded material. The sieve is housed in the lower chamber of the dual-chamber apparatus. The conveyors are provided to transport material within the system for safe shredding, and from the system for safe shredding to any external equipment attached to the system for safe shredding. The motor is connected to the shredder, and, the plurality of sensors and actuators are provided for respectively sensing a plurality of parameters and actuating a plurality of operations in the system.

According to one embodiment of the present invention, the upper chamber of the dual-chamber apparatus is maintained at a constant temperature by electrically heating with submerged water heater and cooling using a heat exchanger or chiller. The upper chamber is connected to an inlet arrangement through which the material to be shredded is introduced into the dual-chamber apparatus. The upper chamber comprises a narrow chamber at the top portion to collect the exhaust gases produced during the shredding operation. The upper chamber further includes a fluid inlet arrangement and a plurality of pressure sensors and temperature sensors.

According to one embodiment of the present invention, the lower chamber of the dual-chamber apparatus houses a sieve placed in the middle of the lower chamber with a tilt and includes a shaking mechanism. The sieve is configured to classify solid and liquid material. The sieve is also configured to classify the shredded material based on their size. The classification of shredded material is also enabled outside the system using external equipment.

According to one embodiment of the present invention, the plurality of conveyors enable the transport of a plurality of types of material within and outside the system. The shredded material that is classified as under-sized using preset parameters is transported out of the system through an outlet conveyor. The shredded material is classified as over-sized using preset parameters is transported for re-shredding and mixed with the feed material that is introduced into the system for shredding through an intra-system conveyor. The intra-system conveyor is run at higher speed than outlet conveyor to create a flow of water inside the equipment for equal distribution of heat. All the conveyors are designed to run at pre-calibrated constant speeds.

According to one embodiment of the present invention, the shredder is mechanically coupled to a motor, where the mechanical coupling is at least one of a belt-drive, a pulley, a plurality of gear-boxes or a plurality of couplers, and wherein, the system comprises a pulley or a flywheel arrangement for creating inertia and compensate for alterations in torque. The system further comprises a mechanism to measure the slippage of the system, thereby identifying any choking in the shredder and reverse the direction of the motion suitably in order to overcome the choking.

According to one embodiment of the present invention, the electrical temperature maintenance system that maintains the temperature of the dua-chamber apparatus is controlled using a PID controlled and further comprises a plurality of temperature sensors to monitor the uniformity of temperature in the chamber.

According to one embodiment of the present invention, the gases exhausted during shredding operation are collected at the top of the dual-chamber apparatus and are then sent to a scrubber to neutralize any gases. This function is accomplished using a control valve, a pressure sensor, the placement of chamber and pump above it to create a negative pressure, and wherein, the organic gases left after scrubbing were compressed and stored.

According to one embodiment of the present invention, upper chamber and lower chamber, along with non-sliding parts of shredder assembly are coated with protective coating such as Teflon or Nickel to protect the equipment from leached products of the shredding operation.

According to one embodiment of the present invention, a system for shredding Lithium-ion batteries is provided. The system comprises a hourglass shaped apparatus and the shredder is placed at the neck of the apparatus. The upper bulb of the hourglass shaped apparatus is electrically heated/cooled using submerged water heater/chillers. The upper bulb is also connected to the material inlet and comprises a chamber at the top for collecting exhaust gases. According to one embodiment, the lower bulb of the hourglass shaped apparatus comprises a screen placed at the middle of the chamber with a tilt and a shaking mechanism. This is a sieve arrangement, and it is used for classification of undersized and oversized material. The undersized material is exported out of the system while the oversized material is cycled back with feed material. The movement of material of both undersized and oversized is accomplished using a plurality of screw conveyors, wherein the screw conveyors are run at pre-calibrated constant speed. The intra equipment conveyor is run at higher speed than outlet conveyor to create a flow of a fluid, such as water, inside the equipment for equal distribution of heat. When intra-equipment screw conveyor is not used, the movement of water is accomplished using pumps. The gases exhausted during shredding operation are collected at top and are sent to a scrubber to neutralize any acidic gases, wherein this function is accomplished using a control valve and pressure sensor. The placement of chamber and pump above it also creates a negative pressure. According to one embodiment, the gases left after scrubbing are compressed and stored. Both the upper bulb and lower bulb, along with the non-sliding parts of shredder assembly, are coated with protective coating such as Teflon or Nickel, to protect the equipment from leached products produced from the shredding operation. The shredder is connected to a motor using a belt drive connected via motor using a large pulley. According to one embodiment, the motor is connected via gears. A pulley is provided to create some inertia in the system so that minor alteration in torque requirement is handled. There is also a mechanism that measures the slippage of belt in the system to detect shredder choke, and when the choke is detected, it reverses the direction of motion for a certain amount of time. The electrical heating system is controlled using a PID controller and a plurality of thermocouples are placed to monitor temperature uniformity.

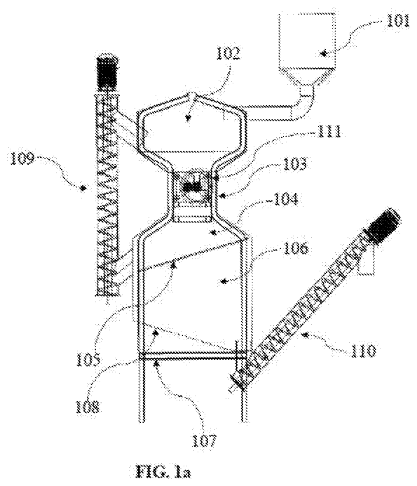

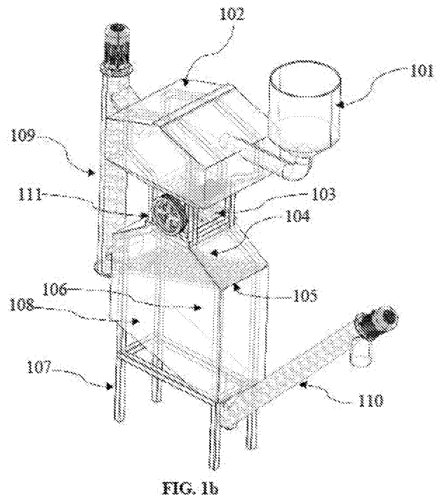

FIGS. 1a and 1b illustrate the front view and isometric views of a system for providing integrated and safe shredding of Lithium-ion batteries. The system comprises a Material hopper 101, an Upper Tank 102, a Shredder Unit 103, a Lower tank 104, a Sieve for Classification of over-sized material 105, the Shredded Material 106, a Supporting Structure 107, a Skin 108, a Screw conveyor-1 109, a Screw conveyor-2 110 and a Pulley 111.

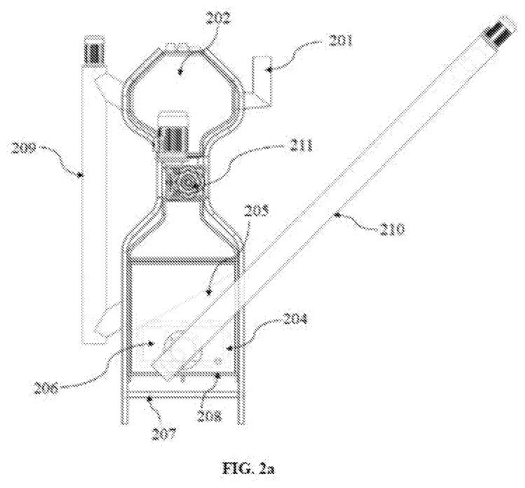

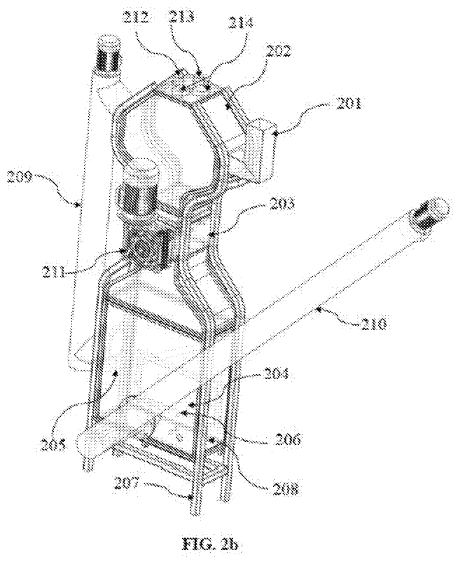

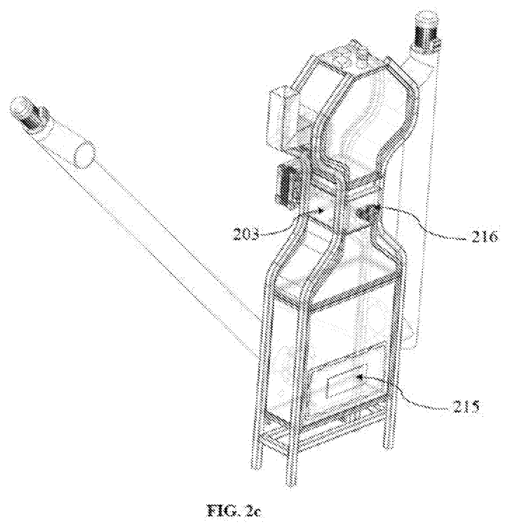

FIGS. 2a, 2b and 2c illustrate the front view and side views of yet another system for providing integrated and safe shredding of Lithium-ion batteries. The system comprises a Material hopper 201, an Upper Tank 202, a Shredder Unit 203, a Lower tank 204, a Sieve 205, Shredded Material 206, a Supporting Structure 207, Skin 208, a first Screw conveyor 209, a second Screw conveyor 210, a Shredder Drive Unit 211, an Exhaust Gas Outlet 212, a Water Inlet 213, a plurality of Pressure Sensors and Temperature Sensors 214, a Viewing Port 215 and a plurality of Gears 216.

Although the embodiments herein are described with various specific embodiments, it will be obvious for a person skilled in the art to practice the embodiments herein with modifications.

### Advantageous Effects of the Invention

The various embodiments of the present invention provide a system for shredding Lithium-ion batteries. The present invention provides a single integrated system that is designed to shred Lithium-ion batteries and handle all the associated complex processes and effects. The present invention also provides a system for classification of shredded material during the shredding of Lithium-ion batteries. The present invention is designed to remove the pre-treatment of batteries and enable the extraction of organics. The present invention also optimizes the use of resources for the operation of shredder.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for safe shredding of Lithium-ion batteries, the system comprising:
a dual-chamber apparatus, wherein the dual-chamber apparatus comprises an upper chamber and a lower chamber such that the two chambers are mechanically coupled through a narrow neck region, and both the chambers broaden as they move away from the neck region, thereby providing an hourglass-shape to the dual-chamber apparatus, and wherein, the dual-chamber apparatus enables safe shredding of Lithium-ion batteries by providing a temperature-controlled fluid environment inside the chambers;
a shredder, wherein the shredder is placed at the neck of the dual-chamber apparatus, and wherein, the width of the shredder is adjusted for size characterization of shredded material;
a sieve, wherein the sieve is housed in the lower chamber of the dual-chamber apparatus;
a plurality of conveyors, wherein the conveyors are provided to transport material within the system for safe shredding, and from the system for safe shredding to any external equipment attached to the system for safe shredding;
a motor, wherein the motor is connected to the shredder; and,
a plurality of sensors and actuators for respectively sensing a plurality of parameters and actuating a plurality of operations in the system.

2. The system as claimed in claim 1, wherein the upper chamber of the dual-chamber apparatus is maintained at a constant temperature by electrically heating with submerged water heater and cooling using a heat exchanger or chiller, and wherein, the upper chamber is connected to an inlet arrangement through which the material to be shredded is introduced into the dual-chamber apparatus, and wherein, the upper chamber comprises a narrow chamber at the top portion to collect the exhaust gases produced during the shredding operation, and wherein, the upper chamber further includes a fluid inlet arrangement and a plurality of pressure sensors and temperature sensors.

3. The system as claimed in claim 1, wherein the lower chamber of the dual-chamber apparatus houses a sieve placed in the middle of the lower chamber with a tilt and includes a shaking mechanism, and wherein, the sieve is configured to classify solid and liquid material, and wherein, the sieve is also configured to classify the shredded material based on their size, and wherein, the classification of shredded material is also enabled outside the system using external equipment.

4. The system as claimed in claim 1, wherein the plurality of conveyors enable the transport of a plurality of types of material within and outside the system, and wherein, the shredded material that is classified as under-sized using preset parameters is transported out of the system through an outlet conveyor, and wherein, the shredded material is classified as over-sized using preset parameters is transported for re-shredding and mixed with the feed material that is introduced into the system for shredding through an intra-system conveyor, and wherein, the intra-system conveyor is run at higher speed than outlet conveyor to create a flow of water inside the equipment for equal distribution of heat, and wherein, all the conveyors are designed to run at pre-calibrated constant speeds.

5. The system as claimed in claim 1, wherein the shredder is mechanically coupled to a motor, where the mechanical coupling is at least one of a belt-drive, a pulley, a plurality of gear-boxes or a plurality of couplers, and wherein, the system comprises a pulley or a flywheel arrangement for creating inertia and compensate for alterations in torque, and wherein, the system further comprises a mechanism to measure the slippage of the system, thereby identifying any choking in the shredder and reverse the direction of the motion suitably in order to overcome the choking.

6. The system as claimed in claim 1, wherein the electrical temperature maintenance system that maintains the temperature of the dua-chamber apparatus is controlled using a PID controlled and further comprises a plurality of temperature sensors to monitor the uniformity of temperature in the chamber.

7. The system as claimed in claim 1, wherein the gases exhausted during shredding operation are collected at the top of the dual-chamber apparatus and are then sent to a scrubber to neutralize any gases, and wherein, this function is accomplished using a control valve, a pressure sensor, the placement of chamber and pump above it to create a negative pressure, and wherein, the organic gases left after scrubbing were compressed and stored.

8. The system as claimed in claim 1, wherein upper chamber and lower chamber, along with non-sliding parts of shredder assembly are coated with protective coating such as Teflon or Nickel to protect the equipment from leached products of the shredding operation.
